(19) United States
(12) Patent Application Publication
(10) Pub. No.: US 2021/0241710 A1
(43) Pub. Date: Aug. 5, 2021

(54) LIQUID CRYSTAL DISPLAY DEVICE AND DRIVE METHOD THEREOF

(71) Applicant: SHARP KABUSHIKI KAISHA, Osaka (JP)

(72) Inventor: OSAMU SASAKI, Osaka (JP)

(21) Appl. No.: 17/109,822

(22) Filed: Dec. 2, 2020

Related U.S. Application Data
(60) Provisional application No. 62/968,960, filed on Jan. 31, 2020.
(60) Provisional application No. 62/971,739, filed on Feb. 7, 2020.

(51) Int. Cl. G09G 3/36

(52) U.S. Cl. CPC G09G 3/3688; G09G 2300/0876; G09G 3/3696; G09G 3/3677

(57) ABSTRACT

A liquid crystal display device includes a display section including scanning lines, data lines, and pixel circuits, a scanning line drive circuit, a data line drive circuit, a first voltage output circuit, and a second voltage output circuit. The pixel circuit includes a liquid crystal capacitance having a pixel electrode, and applies one of a first voltage and a second voltage to the pixel electrode of the liquid crystal capacitance, in accordance with data written by driving the scanning line and the data line. The first voltage output circuit controls the first voltage to have a level that is more distant from the second voltage than a normal level, in accordance with a timing when a voltage of the pixel electrode changes. With this, a reflective type liquid crystal display device performing binary display and capable of preventing an afterimage caused by an orientation abnormality is provided.

### CROSS-REFERENCE TO RELATED APPLICATION

This application claims the benefit of U.S. Provisional Patent Application No. 62/968,960 filed on Jan. 31, 2020 and entitled “Liquid Crystal Display Device And Drive Method Thereof”, and the benefit of U.S. Provisional Patent Application No. 62/971,739 filed on Feb. 7, 2020 and entitled “Liquid Crystal Display Device And Drive Method Thereof”, which are incorporated herein by reference in its entirety.

### BACKGROUND OF THE INVENTION

### Field of the Invention

The present invention relates to a display device, especially to a liquid crystal display device and a drive method thereof.

### Description of Related Art

A reflective type liquid crystal display device performing binary display is used in a display section of an electronic device, and the like. Apart from this, there is known a memory type liquid crystal display device including pixel circuits that digitally memorize written data. According to the memory type liquid crystal display device, a number of data writing to the pixel circuit can be reduced, and a power consumption of the liquid crystal display device can be reduced.

Related to the invention of the present application, Japanese Laid-Open Patent Publication H7-294881 discloses a liquid crystal display device that applies a plurality of voltages which are different from each other, to liquid crystal of each pixel in one frame period in order to improve a viewing angle characteristic.

The reflective type liquid crystal display device performing the binary display has a problem that an afterimage occurs in a display screen when a display image is switched. FIG. 15 is a diagram showing how the afterimage occurs in a conventional liquid crystal display device. FIG. 15 describes a change of a display screen of a reflective type and memory type liquid crystal display device performing the binary display. When a screen Z1 displaying a black triangle is switched to a screen Z2 displaying a white triangle, it is desirable that the screen Z1 be switched to the screen Z2 immediately. However, in the conventional liquid crystal display device, there occurs an orientation abnormality called discrination, and a screen Zx including an afterimage (intermediate color portion in the triangle) is displayed between the screen Z1 and the screen Z2.

FIG. 16 is an enlarged diagram of a display section of the conventional liquid crystal display device. FIG. 16 describes nine pixels arranged two-dimensionally. When an electric field is applied between a pixel electrode and a common electrode of a pixel Pc, orientations of liquid crystal molecules positioned at the pixel Pc are changed in accordance with the applied electric field. However, the liquid crystal molecules existing in a surrounding portion (broken line portion) of the pixel Pc is in a state of being difficult to move, because they are affected by electric fields from the pixel electrodes of neighboring pixels or neighboring wirings. Thus, even if the electric field is applied between the pixel electrode and the common electrode of the pixel Pc, the orientations of the liquid crystal molecules existing in the surrounding portion of the pixel Pc does not change immediately, and the orientation abnormality occurs. While the orientations are abnormal, the afterimage is visually recognized by an observer.

### SUMMARY OF THE INVENTION

Therefore, providing a reflective type liquid crystal display device performing binary display capable of preventing an afterimage caused by an orientation abnormality is taken as a problem.

(1) A liquid crystal display device according to some embodiments of the present invention is a reflective type liquid crystal display device performing binary display, the device includes: a display section including scanning lines, data lines, and pixel circuits; a scanning line drive circuit configured to drive the scanning lines; a data line drive circuit configured to drive the data lines; a first voltage output circuit configured to output a first voltage; and a second voltage output circuit configured to output a second voltage, the pixel circuit includes a liquid crystal capacitance having a pixel electrode, and is configured to apply one of the first voltage and the second voltage to the pixel electrode in accordance with data written by driving the scanning line and the data line, and the first voltage output circuit is configured to control the first voltage to have a level that is more distant from the second voltage than a normal level, in accordance with a timing when a voltage of the pixel electrode changes.

(2) The liquid crystal display device according to some embodiments of the present invention has the configuration of above (1), and the first voltage output circuit is configured to make the first voltage change in an impulse manner in accordance with the timing.

(3) The liquid crystal display device according to some embodiments of the present invention has the configuration of above (1), and the first voltage output circuit is configured to make the first voltage change in a rectangular pulse manner in accordance with the timing.

(4) The liquid crystal display device according to some embodiments of the present invention has the configuration of above (1), and the second voltage output circuit is configured to control the second voltage to have a constant level in a frame period.

(5) The liquid crystal display device according to some embodiments of the present invention has the configuration of above (1), and the second voltage output circuit is configured to control the second voltage to have a level that is more distant from the first voltage than a normal level, in accordance with the timing.

(6) The liquid crystal display device according to some embodiments of the present invention has the configuration of above (5), and the second voltage output circuit is configured to make the second voltage change in an impulse manner in accordance with the timing.

(7) The liquid crystal display device according to some embodiments of the present invention has the configuration of above (5), and the second voltage output circuit is configured to make the second voltage change in a rectangular pulse manner in accordance with the timing.

(8) The liquid crystal display device according to some embodiments of the present invention has the configuration of above (1), and the first voltage output circuit is configured to output, as the first voltage, a same voltage to all of the pixel circuits, and to control the first voltage in accordance with all of the timings when the voltage of the pixel electrode changes.

(9) The liquid crystal display device according to some embodiments of the present invention has the configuration of above (1), the pixel circuits are classified into groups corresponding to the scanning lines, and the first voltage output circuit is configured to output, as the first voltage, voltages corresponding to the groups, and to control the first voltage that corresponds to the group, in accordance with a timing when the voltage of the pixel electrode in the pixel circuit in the group changes.

(10) The liquid crystal display device according to some embodiments of the present invention has the configuration of above (1), the device further includes a common electrode drive circuit configured to drive a common electrode of the liquid crystal capacitance, and the first voltage output circuit, the second voltage output circuit, and the common electrode drive circuit are configured to invert a level of a voltage output from each circuit, for each frame period.

(11) The liquid crystal display device according to some embodiments of the present invention has the configuration of above (1), and the pixel circuit includes: a write control transistor having a control terminal connected to the scanning line, and one conduction terminal connected to the data line; a memory circuit configured to memorize the data input through the write control transistor, and to output a control signal in accordance with the data;

and a voltage selection circuit configured to apply one of the first voltage and the second voltage to the pixel electrode according to the control signal.

(12) The liquid crystal display device according to some embodiments of the present invention has the configuration of above (11), the memory circuit is a flip-flop circuit configured to output, as the control signal, a first control signal and a second control signal that change complementarily, and the voltage selection circuit includes: a transistor configured to apply the first voltage to the pixel electrode according to the first control signal; a transistor configured to apply the second voltage to the pixel electrode according to the first control signal; a transistor configured to apply the first voltage to the pixel electrode according to the second control signal; and a transistor configured to apply the second voltage to the pixel electrode according to the second control signal.

(13) A drive method of a liquid crystal display device according to some embodiments of the present invention is a drive method of a reflective type liquid crystal display device having a display section including scanning lines, data lines, and pixel circuits, and performing binary display, the method includes: driving the scanning lines; driving the data lines; outputting a first voltage; and outputting a second voltage, the pixel circuit includes a liquid crystal capacitance having a pixel electrode, and is configured to apply one of the first voltage and the second voltage to the pixel electrode in accordance with data written by driving the scanning line and the data line, and in outputting the first voltage, the first voltage is controlled to have a level that is more distant from the second voltage than a normal level, in accordance with a timing when a voltage of the pixel electrode changes.

According to the above-described liquid crystal display device and the drive method thereof, by controlling the first voltage to have the level that is more distant from the second voltage than the normal level in accordance with the timing when the voltage of the pixel electrode changes, a trigger for liquid crystal molecules included in the liquid crystal capacitance to start to move can be provided. Therefore, orientations of the liquid crystal molecules existing in a surrounding portion of a pixel can be changed quickly, and an afterimage caused by an orientation abnormality that occurs when a display image is switched can be prevented.

These and other objects, features, modes and effects of the present invention will be more apparent from the following detailed description with reference to the attached drawings.

### BRIEF DESCRIPTION OF THE DRAWINGS

FIG. 1 is a block diagram showing a configuration of a liquid crystal display device according to a first embodiment.

FIG. 2 is a diagram showing a detailed configuration of the liquid crystal display device according to the first embodiment.

FIG. 3 is a circuit diagram of a pixel circuit of the liquid crystal display device according to the first embodiment.

FIG. 4 is a diagram showing an example of changes of luminance of pixels in the liquid crystal display device according to the first embodiment.

FIG. 5 is a timing chart of the liquid crystal display device according to the first embodiment.

FIG. 6 is a detailed timing chart of the liquid crystal display device according to the first embodiment.

FIG. 7 is a diagram continued from FIG. 6.

FIG. 8 is a detailed timing chart of a liquid crystal display device according to a comparative example.

FIG. 9 is a timing chart of a liquid crystal display device according to a second embodiment.

FIG. 10 is a detailed timing chart of the liquid crystal display device according to the second embodiment.

FIG. 11 is a timing chart of a liquid crystal display device according to a third embodiment.

FIG. 12 is a timing chart of a liquid crystal display device according to a modification example of the third embodiment.

FIG. 13 is a diagram showing a detailed configuration of a liquid crystal display device according to a fourth embodiment.

FIG. 14 is a timing chart of the liquid crystal display device according to the fourth embodiment.

FIG. 15 is a diagram showing how an afterimage occurs in a conventional liquid crystal display device.

FIG. 16 is an enlarged diagram of a display section of the conventional liquid crystal display device.

### DETAILED DESCRIPTION OF THE INVENTION

### First Embodiment

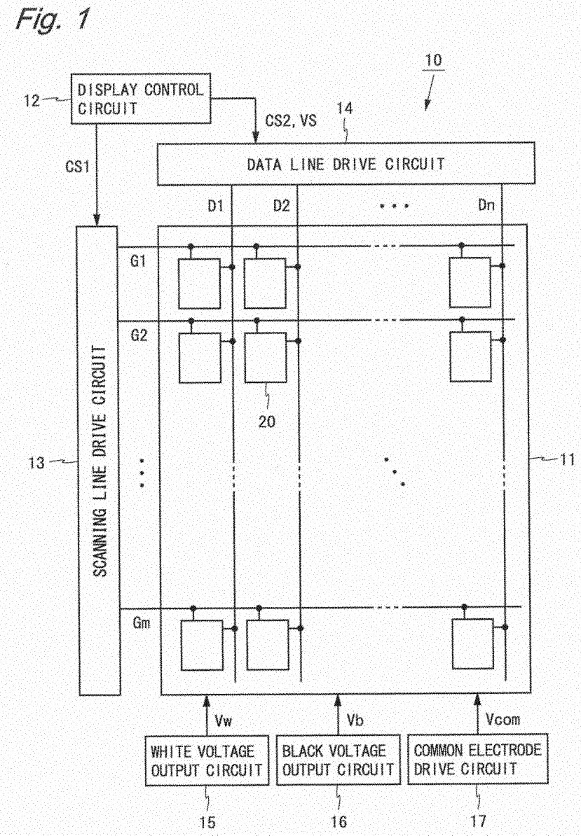

FIG. 1 is a block diagram showing a configuration of a liquid crystal display device according to a first embodiment. A liquid crystal display device 10 shown in FIG. 1 includes a display section 11, a display control circuit 12, a scanning line drive circuit 13, a data line drive circuit 14, a white voltage output circuit 15, a black voltage output circuit 16, and a common electrode drive circuit 17. The liquid crystal display device 10 is a reflective type and memory type liquid crystal display device performing binary display. In the following, it is assumed that m and n are integers not less than two, i is an integer not less than one and not more than m, and j is an integer not less than one and not more than n.

The display section 11 includes m scanning lines G1 to Gm, n data lines D1 to Dn, and (m×n) pixel circuits 20. The scanning lines G1 to Gm are arranged in parallel to each other. The data lines D1 to Dn are arranged in parallel to each other so as to intersect with the scanning lines G1 to Gm perpendicularly. The scanning lines G1 to Gm and the data lines D1 to Dn intersect at (m×n) points. The (m×n) pixel circuits 20 are two-dimensionally arranged corresponding to intersections of the scanning lines G1 to Gm and the data lines D1 to Dn. The pixel circuit 20 is connected to one scanning line and one data line.

The display control circuit 12 outputs a control signal CS1 to the scanning line drive circuit 13, and outputs a control signal CS2 and a video signal VS to the data line drive circuit 14. The control signal CS1 includes a gate clock GCK, and the like. The scanning line drive circuit 13 drives the scanning lines G1 to Gm based on the control signal CS1. The data line drive circuit 14 drives the data lines D1 to Dn based on the control signal CS2 and the video signal VS.

More specifically, the scanning line drive circuit 13 sequentially selects one scanning line from among the scanning lines G1 to Gm based on the control signal CS1, and applies a write voltage (here, a high-level voltage) to the selected scanning line. With this, n pixel circuits 20 connected to the selected scanning line are selected collectively. The data line drive circuit 14 respectively applies n voltages in accordance with the video signal VS to the data lines D1 to Dn based on the control signal CS2. With this, n pieces of data are written to the selected n pixel circuits 20, respectively. The pixel circuit 20 corresponds to a pixel, and the data written to the pixel circuit 20 is binary data. A color of the pixel becomes white or black in accordance with the data written to the pixel circuit 20.

The white voltage output circuit 15 outputs a voltage for displaying white (hereinafter referred to as a white voltage Vw). The black voltage output circuit 16 outputs a voltage for displaying black (hereinafter referred to as a black voltage Vb). The common electrode drive circuit 17 outputs a common electrode voltage Vcom. The pixel circuit includes a liquid crystal capacitance having a pixel electrode, and applies one of the white voltage Vw and the black voltage Vb to the pixel electrode in accordance with the data written by driving a scanning line Gi and a data line Dj. The common electrode drive circuit 17 drives a common electrode of the liquid crystal capacitance.

The display control circuit 12 outputs control signals (not shown) to the white voltage output circuit 15, the black voltage output circuit 16, and the common electrode drive circuit 17. The white voltage output circuit 15, the black voltage output circuit 16, and the common electrode drive circuit 17 invert a level of a voltage output from each circuit, for each frame period based on the control signals output from the display control circuit 12. With this, the liquid crystal display device 10 performs frame inversion drive in which a polarity of a voltage applied to the liquid crystal capacitance is inverted for each frame period.

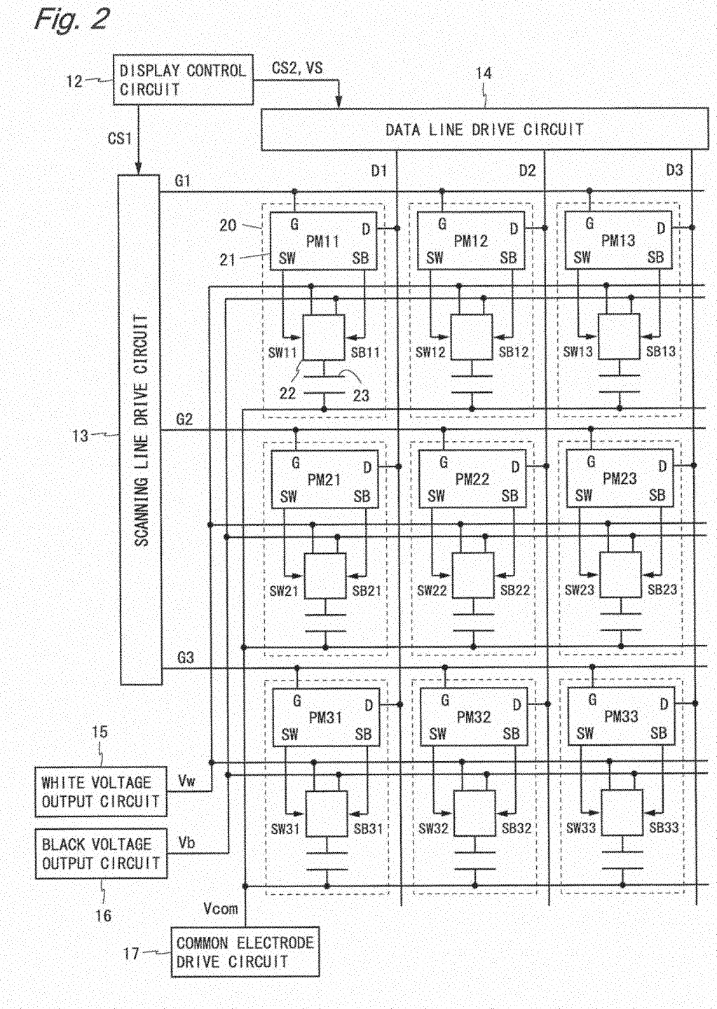

A case where m=n=3 will be described below. FIG. 2 is a diagram showing a detailed configuration of the liquid crystal display device 10. As shown in FIG. 2, the pixel circuit 20 includes a pixel memory 21, a voltage selection circuit 22, and a liquid crystal capacitance 23. A symbol Pij is depicted on the pixel memory 21 in the pixel circuit 20 in an i-th row and a j-th column. The pixel memory 21 in the pixel circuit 20 in the i-th row and the j-th column is connected to the scanning line Gi and the data line Dj, and outputs control signals SWij, SBij.

The white voltage Vw output from the white voltage output circuit 15 and the black voltage Vb output from the black voltage output circuit 16 are provided to two input terminals of the voltage selection circuit 22, respectively. The control signals SWij, SBij are provided to two control terminals of the voltage selection circuit 22, respectively. An output terminal of the voltage selection circuit 22 is connected to the pixel electrode (upper-side electrode in FIG. 2) of the liquid crystal capacitance 23. The common electrode voltage Vcom output from the common electrode drive circuit 17 is applied to the common electrode of the liquid crystal capacitance 23. A high-level voltage VDD and a low-level voltage VSS are supplied to the pixel circuit 20 using wirings not shown.

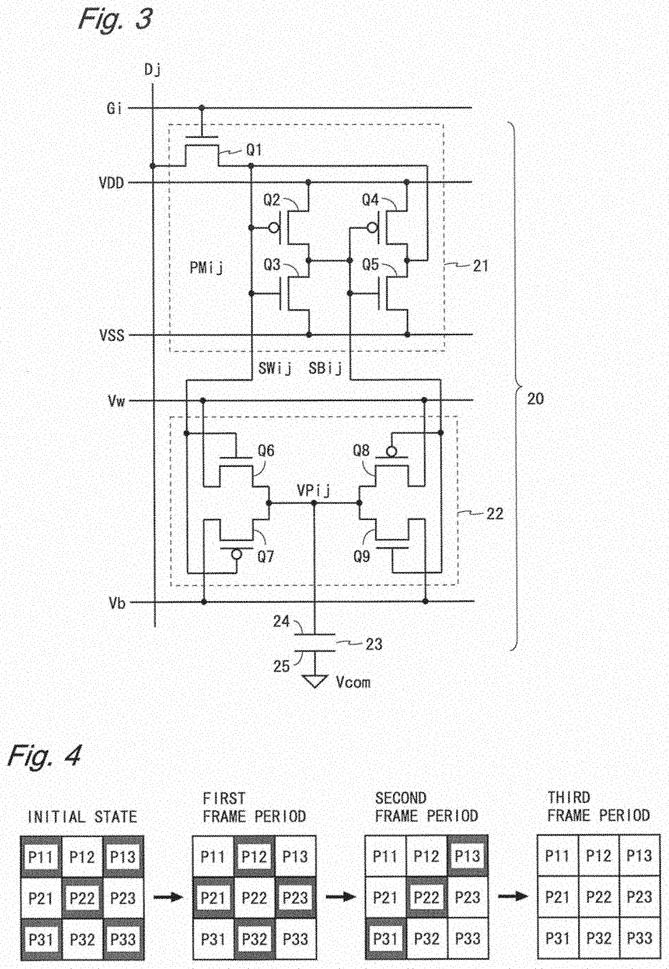

FIG. 3 is a circuit diagram of the pixel circuit 20. FIG. 3 describes the pixel circuit 20 in the i-th row and the j-th column. The pixel circuit 20 includes nine thin film transistors (hereinafter referred to as TFTs) Q1 to Q9, and the liquid crystal capacitance 23. The TFTs Q1, Q3, Q5, Q6, Q9 are N-channel type TFTs, and the TFTs Q2, Q4, Q7, Q8 are P-channel type TFTs. The liquid crystal capacitance 23 has a pixel electrode 24 and a common electrode 25. Note that although the common electrode 25 is depicted for each pixel circuit 20 in FIGS. 2 and 3, the common electrode 25 is commonly provided to all of the pixel circuits 20 in reality.

A gate terminal of the TFT Q1 is connected to the scanning line Gi. One conduction terminal (left-side terminal in FIG. 3) of the TFT Q1 is connected to the data line Dj. The other conduction terminal of the TFT Q1 and drain terminals of the TFTs Q4, Q5 are connected to gate terminals of the TFTs Q2, Q3, Q6, Q7. The control signal SWij is a signal on a wiring connecting these terminals. Drain terminals of the TFTs Q2, Q3 are connected to gate terminals of the TFTs Q4, Q5, Q8, Q9. The control signal SBij is a signal on a wiring connecting these terminals.

The high-level voltage VDD is applied to source terminals of the TFTs Q2, Q4. The low-level voltage VSS is applied to source terminals of the TFTs Q3, Q5. The white voltage Vw is applied to one conduction terminal (left-side terminal in FIG. 3) of the TFT Q6 and one conduction terminal (right-side terminal in FIG. 3) of the TFT Q8. The black voltage Vb is applied to one conduction terminal (left-side terminal in FIG. 3) of the TFT Q7 and one conduction terminal (right-side terminal in FIG. 3) of the TFT Q9. The other conduction terminals of the TFTs Q6 to Q9 are connected to the pixel electrode 24 of the liquid crystal capacitance 23. The common electrode voltage Vcom is applied to the common electrode 25 of the liquid crystal capacitance 23.

The TFT Q1 functions as a write control transistor. The TFTs Q2 to Q5 function as a flip-flop circuit. When a voltage of the scanning line Gi is at a high level, the TFT Q1 turns on, and a voltage of the data line Dj is input to the flip-flop circuit through the TFT Q1. With this, data is written to the flip-flop circuit. While the voltage of the scanning line Gi is at a low level, the flip-flop circuit retains the written data. The control signal SWij has a level corresponding to the data retained in the flip-flop circuit. The control signals SWij, SBij change complementarily (when one is at the high level, the other is at the low level). The flip-flop circuit including the TFTs Q2 to Q5 functions as a memory circuit configured to memorize the data input through the TFT Q1, and to output the control signals SWij, SBij that change complementarily in accordance with the memorized data.

A voltage of the pixel electrode 24 in the pixel circuit 20 in the i-th row and the j-th column is hereinafter referred to as VPij. The TFT Q6 applies the white voltage Vw to the pixel electrode 24 according to the control signal SWij. The TFT Q7 applies the black voltage Vb to the pixel electrode 24 according to the control signal SWij. The TFT Q8 applies the white voltage Vw to the pixel electrode 24 according to the control signal SBij. The TFT Q9 applies the black voltage Vb to the pixel electrode 24 according to the control signal SBij. When the control signal SWij is at the high level and the control signal SBij is at the low level, the TFTs Q6, Q8 turn on, the TFTs Q7, Q9 turn off, and the voltage VPij becomes equal to the white voltage Vw. When the control signal SWij is at the low level and the control signal SBij is at the high level, the TFTs Q6, Q8 turn off, the TFTs Q7, Q9 turn on, and the voltage VPij becomes equal to the black voltage Vb. The TFTs Q6 to Q9 function as the voltage selection circuit 22 that applies one of the white voltage Vw and the black voltage Vb to the pixel electrode 24 according to the control signals SWij, SBij.

FIG. 4 is a diagram showing an example of changes of a display screen of the liquid crystal display device 10. A pixel in the i-th row and the j-th column is hereinafter referred to as Pij. In the example shown in FIG. 4, in an initial state, colors of pixels P12, P21, P23, P32 are white, and colors of other pixels are black. In a first frame period, the colors of the pixels P12, P21, P23, P32 change to black, and the colors of the other pixels change to white. In a second frame period, the colors of the pixels P12, P21, P23, P32 change to white, and colors of pixels P13, P22, P31 change to black. In a third frame period, the colors of the pixels P13, P22, P31 change to white.

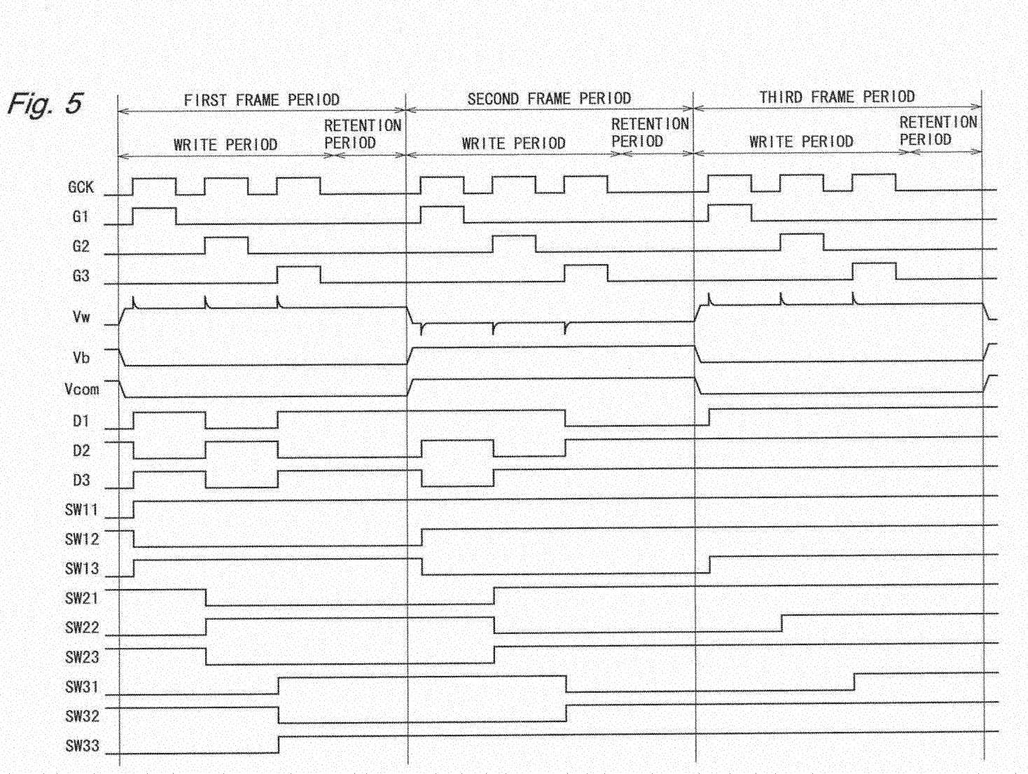

FIG. 5 is a timing chart of the liquid crystal display device 10. FIG. 5 describes changes of signals and voltages in the first to third frame periods when the display screen changes as shown in FIG. 4. As shown in FIG. 5, one frame period is divided into a write period and a retention period. In the retention period, all of the signals and the voltages do not change.

The gate clock GCK becomes the high level three times in one frame period. High-level periods of the gate clock GCK are hereinafter referred to as first to third selection periods in an order of appearance. Voltages of the scanning lines G1 to G3 become the high level in the first to third selection periods, respectively. Voltages of the data lines D1 to D3 become levels corresponding to the video signal VS in beginnings of the first to third selection periods. Note that there are a case where the voltages of the data lines D1 to D3 change from those in a previous selection period, and a case where the voltages of the data lines D1 to D3 do not change from those in the previous selection period.

The white voltage output circuit 15 outputs, as the white voltage Vw, a same voltage to all of the pixel circuits 20. The white voltage Vw becomes the high level in odd-numbered frame periods, and becomes the low level in even-numbered frame periods. The white voltage output circuit 15 controls the white voltage Vw in a later-described manner in accordance with a timing when the voltage of the pixel electrode 24 changes.

The black voltage output circuit 16 outputs, as the black voltage Vb, a same voltage to all of the pixel circuits 20. The black voltage Vb becomes the low level in the odd-numbered frame periods, and becomes the high level in the even-numbered frame periods. The black voltage output circuit 16 controls the black voltage Vb to have a constant level in the frame period. The common electrode drive circuit 17 controls the common electrode voltage Vcom to have a constant level in the frame period. The common electrode voltage Vcom becomes the low level in the odd-numbered frame periods, and becomes the high level in the even-numbered frame periods.

The voltages of the scanning lines G1 to G3 become the high level in the first to third selection periods, respectively, and the voltages of the data lines D1 to D3 become levels in accordance with the video signal VS in the beginnings of the first to third selection periods. Thus, in the beginnings of the first to third selection periods, the TFT Q1 turns on, and the voltage of the data line Dj is input to the flip-flop circuit through the TFT Q1. Therefore, in the beginning of an i-th selection period, the control signal SWij becomes a level in accordance with the video signal VS, and the control signal SBij becomes a level which is opposite to that of the control signal SWij.

For example, in the beginning of the first selection period in the first frame period, the voltages of the data lines D1 to D3 become the high level, the low level, and the high level, respectively. Thus, in the beginning of a first write period in the first frame period, control signals SW11 to SW13 become the high level, the low level, and the high level, respectively, and control signals SB11 to SB13 (not shown) become the low level, the high level, and the low level, respectively.

The white voltage output circuit 15 controls the white voltage Vw to have a level that is more distant from the black voltage Vb than a normal level (final level that the white voltage Vw should have), in accordance with the timing when the voltage of the pixel electrode 24 changes. More specifically, a control period that is sufficiently short compared to the selection period is set in the beginning of each selection period. The white voltage output circuit 15 controls the white voltage Vw to have the level that is more distant from the black voltage Vb than the normal level, in an impulse manner in each control period.

Thus, in the odd-numbered frame periods when the black voltage Vb is at the low level, the white voltage Vw becomes higher than a normal high level in the impulse manner in the beginning of each selection period. In the even-numbered frame periods when the black voltage Vb is at the high level, the white voltage Vw becomes lower than a normal low level in the impulse manner in the beginning of each selection period.

Length of the control period, and a highest level and a lowest level of the white voltage Vw in the control period are determined so that later-described effects can be attained. For example, the highest level of the white voltage Vw in the control period is determined to have a level that is higher than the normal high level by about 10% of a difference between the white voltage Vw and the black voltage Vb. The lowest level of the white voltage Vw in the control period is determined to have a level that is lower than the normal low level by about 10% of the above-described difference.

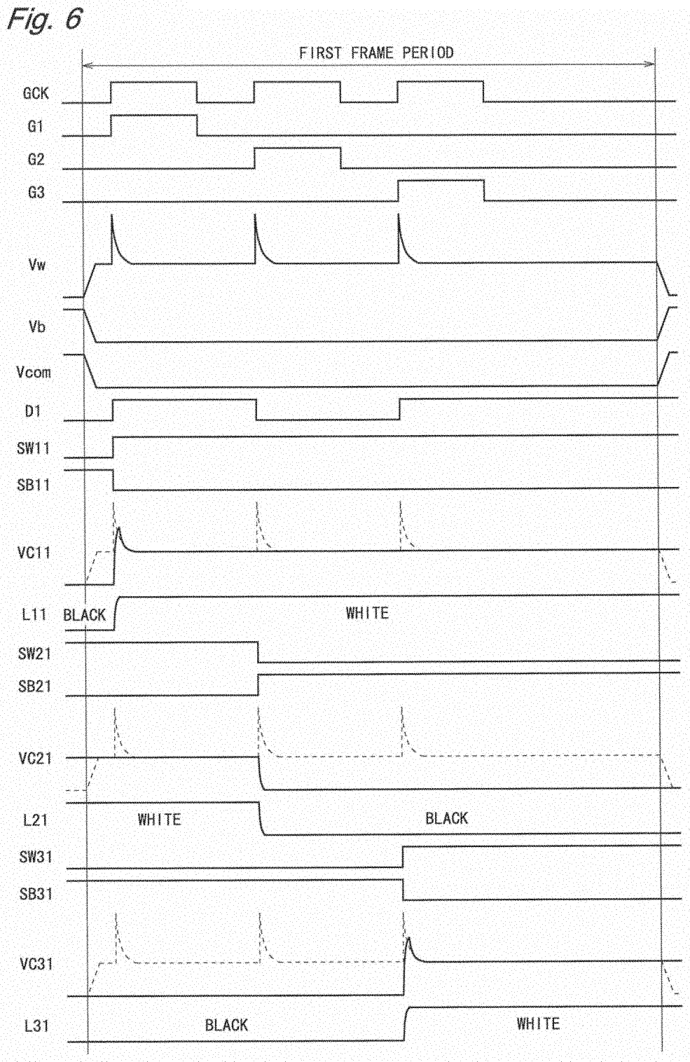

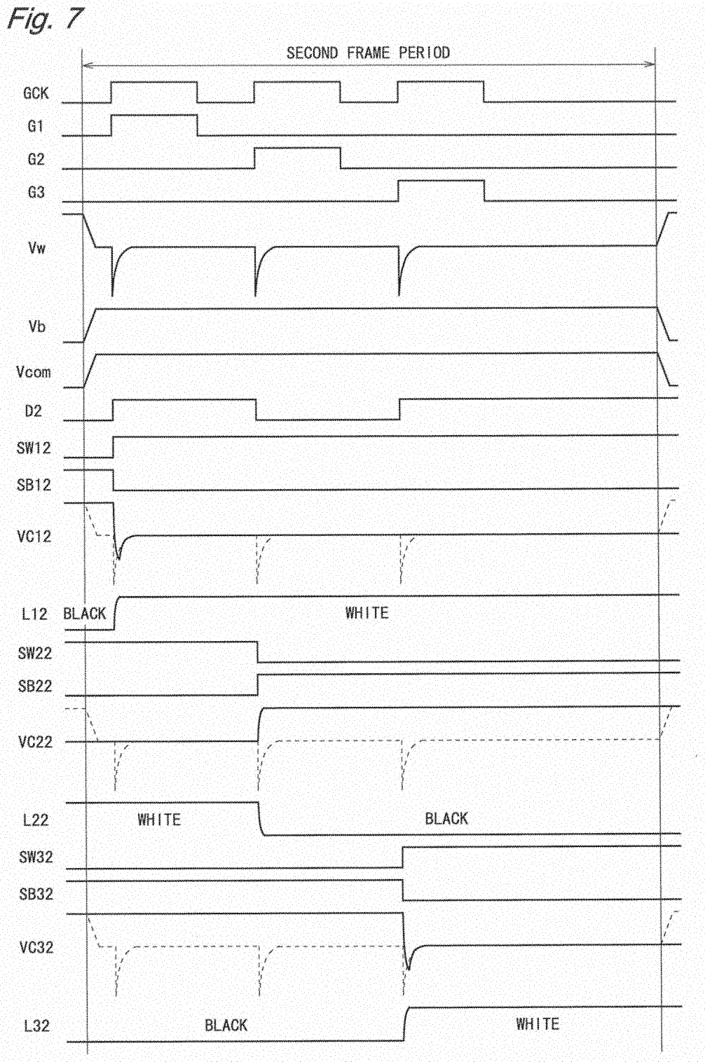

FIG. 6 is a detailed timing chart of the liquid crystal display device 10. FIG. 7 is a diagram continued from FIG. 6. FIG. 6 describes changes of the signals and the voltages in the first frame period, and FIG. 7 describes the changes of the signals and the voltages in the second frame period. In FIGS. 6 and 7, VCij represents a voltage applied to the liquid crystal capacitance 23 in the pixel circuit 20 in the i-th row and the j-th column, Lij represents luminance (transparency) of the pixel Pij in the i-th row and the j-th column. Note that, in order to facilitate understanding of the drawings, a waveform of the white voltage Vw is depicted using a broken line overlapping on a waveform of the voltage VCij, and portions where the white voltage Vw changes in the impulse manner are depicted in an enlarged manner in an amplitude direction and a time direction.

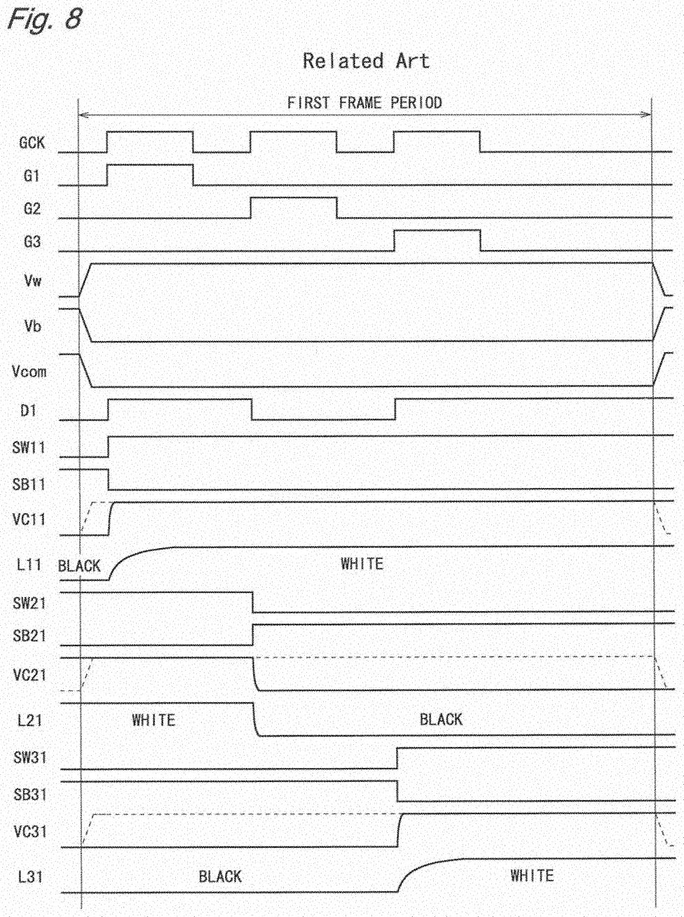

As a liquid crystal display device according to a comparative example, there is considered a liquid crystal display device having the same configuration as the liquid crystal display device 10, in which the white voltage Vw does not change in the impulse manner in the beginning of each selection period. FIG. 8 is a detailed timing chart of the liquid crystal display device according to the comparative example. FIG. 8 describes changes of the signals and the voltages in the same case as FIG. 6 with respect to the liquid crystal display device according to the comparative example.

Referring to FIGS. 6 to 8, effects of the liquid crystal display device 10 according to the present embodiment will be described. In FIGS. 6 and 8, in the beginning of the first selection period in the first frame period, the voltage of the scanning line G1 changes to the high level, and the voltage of the data line D1 also changes to the high level. Thus, in the pixel circuit 20 in a first row and a first column, the control signal SW11 changes to the high level, the control signal SB11 changes to the low level, and a voltage VP11 (not shown) of the pixel electrode 24 changes to the high level. The common electrode voltage Vcom is at the low level in the first frame period. Therefore, the voltage VC11 applied to the liquid crystal capacitance 23 changes from the low level to the high level, and accordingly a color of the pixel P11 changes from black to white. The liquid crystal display device 10 and the liquid crystal display device according to the comparative example are the same with respect to the points described so far.

In the liquid crystal display device according to the comparative example (FIG. 8), liquid crystal molecules positioned in a surrounding portion of the pixel P11 are in a state of being difficult to move, because they are affected by electric field from the pixel electrodes of neighboring pixels and neighboring wirings. Thus, even if an electric field is applied between the pixel electrode and the common electrode of the pixel P11 in the beginning of the first selection period in the first frame period, orientations of the liquid crystal molecules existing in the surrounding portion of the pixel P11 do not change immediately, and an orientation abnormality occurs. Thus, luminance L11 of the pixel P11 changes slowly. Similar phenomena occur in other selection periods when the color of the pixel changes from black to white.

On the contrary, in the liquid crystal display device (FIGS. 6 and 7), the white voltage output circuit 15 controls the white voltage Vw to have the level that is distant from the black voltage Vb in the impulse manner, in accordance with the timing when the voltage of the pixel electrode 24 changes. For example, the white voltage Vw becomes higher than the normal high level in the impulse manner in the beginning of the first selection period in the first frame period. Thus, the voltage VC11 applied to the liquid crystal capacitance 23 in the pixel circuit 20 in the first row and the first column becomes higher than the normal level in the impulse manner in the beginning of the first selection period in the first frame period. With this, even if the liquid crystal molecules existing in the surrounding portion of the pixel P11 are in the state of being difficult to move, a trigger for the liquid crystal molecules included in the liquid crystal capacitance 23 to start to move can be provided. Therefore, the orientations of the liquid crystal molecules existing in the surrounding portion of the pixel P11 can be changed quickly, and an afterimage caused by the orientation abnormality that occurs when a display image is switched can be prevented. Furthermore, by controlling the white voltage Vw in the impulse manner in accordance with the timing when the voltage of the pixel electrode 24 changes, the white voltage Vw having the normal level can be applied after the liquid crystal molecules start to move, and the color of the pixel P11 can be controlled to be white. Similar effects can be attained in other selection periods when the color of the pixel changes from black to white.

As described above, the liquid crystal display device 10 according to the present embodiment is a reflective type liquid crystal display device performing the binary display, and includes the display section 11 including the scanning lines G1 to Gm, the data lines D1 to Dn, and the pixel circuits 20, the scanning line drive circuit 13 that drives the scanning lines G1 to Gm, the data line drive circuit 14 that drives the data lines D1 to Dn, a first voltage output circuit (white voltage output circuit 15) that outputs a first voltage (white voltage Vw), and a second voltage output circuit (black voltage output circuit 16) that outputs a second voltage (black voltage Vb). The pixel circuit 20 includes the liquid crystal capacitance 23 having the pixel electrode 24, and applies one of the first voltage and the second voltage to the pixel electrode 24 in accordance with the data written by driving the scanning line Gi and the data line Dj. The first voltage output circuit controls the first voltage to have a level that is more distant from the second voltage than the normal level (a level higher than the normal high level, or a level lower than the normal low level), in accordance with the timing when the voltage of the pixel electrode 24 changes.

According to the liquid crystal display device 10 according to the present embodiment, by controlling the first voltage to have the level that is more distant from the second voltage than the normal level, in accordance with the timing when the voltage of the pixel electrode 24 changes, a trigger for the liquid crystal molecules included in the liquid crystal capacitance 23 to start to move can be provided. Therefore, the orientations of the liquid crystal molecules existing in the surrounding portion of the pixel can be changed quickly, and the afterimage caused by the orientation abnormality that occurs when the display image is switched can be prevented.

The first voltage output circuit makes the first voltage change in the impulse manner in accordance with the above-described timing. Therefore, the first voltage having the normal level can be applied after the liquid crystal molecules start to move, and the color of the pixel can be controlled to be a color corresponding to the first voltage.

The second voltage output circuit controls the second voltage to have a constant level in the frame period. Therefore, the above-described effects can be attained without performing any special control with respect to the second voltage. The first voltage output circuit outputs, as the first voltage, a same voltage to all of the pixel circuits 20, and controls the first voltage in accordance with all of the timings when the voltage of the pixel electrode 24 changes. Therefore, the above-described effects can be attained with a simple configuration.

The liquid crystal display device 10 further includes the common electrode drive circuit 17 that drives the common electrode 25 of the liquid crystal capacitance 23, and the first voltage output circuit, the second voltage output circuit, and the common electrode drive circuit 17 invert a level of a voltage output from each circuit, for each frame period. Therefore, the above-described effects can be attained with respect to a liquid crystal display device performing frame inversion drive.

The pixel circuit 20 further includes a write control transistor (TFT Q1) having a control terminal (gate terminal) connected to the scanning line Gi, and one conduction terminal connected to the data line Dj, a memory circuit (flip-flop circuit) that memorizes the data input through the write control transistor and outputs the control signals SWij, SBij in accordance with the data, and the voltage selection circuit 22 that applies one of the first voltage and the second voltage to the pixel electrode 24 according to the control signals SWij, SBij. Therefore, the above-described effects can be attained with respect to a memory type liquid crystal display device.

The memory circuit is the flip-flop circuit that outputs, as the control signal, a first control signal (control signal SWij) and a second control signal (control signal SBij) that change complementarily, and the voltage selection circuit 22 includes a transistor (TFT Q6) that applies the first voltage to the pixel electrode 24 according to the first control signal, a transistor (TFT Q7) that applies the second voltage to the pixel electrode 24 according to the first control signal, a transistor (TFT Q8) that applies the first voltage to the pixel electrode 24 according to the second control signal, and a transistor (TFT Q9) that applies the second voltage to the pixel electrode 24 according to the second control signal. Therefore, the above-described effects can be attained with respect to a memory type liquid crystal display device including such a pixel circuit 20.

Note that, it is assumed that in the liquid crystal display device according to the present embodiment, a timing when the voltage of the scanning line Gi becomes the high level and a timing when the voltage of the data line Dj becomes a level in accordance with the video signal VS are almost the same. In a case where the two timings are different, the voltage of the pixel electrode 24 changes according to a later timing. Therefore, in this case, it is enough for the white voltage output circuit 15 to make the white voltage Vw change in the impulse manner in accordance with the later timing.

### Second Embodiment

A liquid crystal display device according to a second embodiment has the same configuration (FIGS. 1 to 3) as that of the liquid crystal display device 10 according to the first embodiment, and controls the white voltage in a manner different from that of the first embodiment. Differences from the first embodiment will be described below.

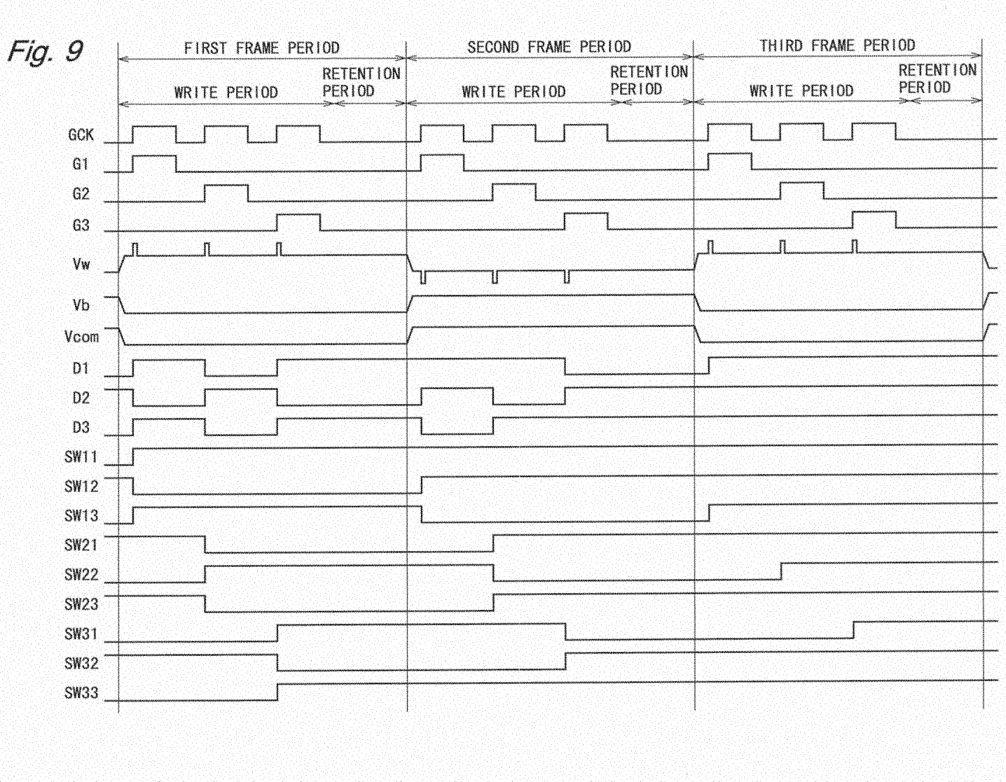

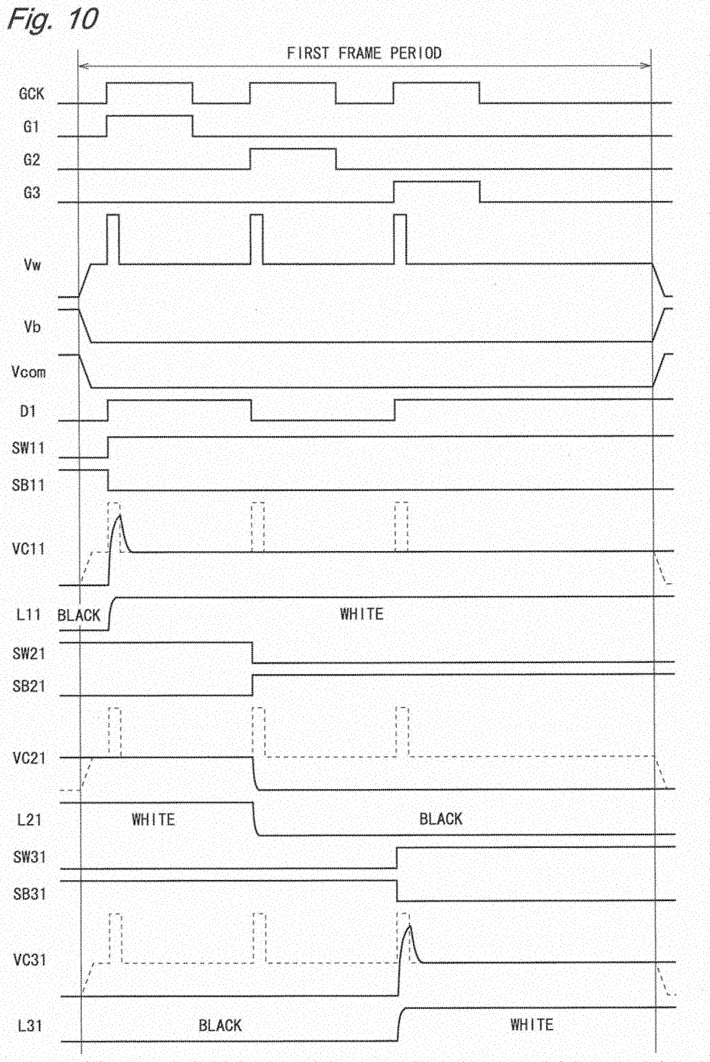

FIG. 9 is a timing chart of the liquid crystal display device according to the present embodiment. FIG. 9 describes changes of the signals and the voltages in the same case as FIG. 5 with respect to the liquid crystal display device according to the present embodiment. FIG. 10 is a detailed timing chart of the liquid crystal display device according to the present embodiment. FIG. 10 describes changes of the signals and the voltages in the first frame period.

As shown in FIGS. 9 and 10, also in the liquid crystal display device according to the present embodiment, the white voltage output circuit 15 controls the white voltage Vw to have the level that is more distant from the black voltage Vb than the normal level in accordance with the timing when the voltage of the pixel electrode 24 changes. However, in the present embodiment, differently from the first embodiment, the white voltage output circuit 15 makes the white voltage Vw change in a rectangular pulse manner in accordance with the timing when the voltage of the pixel electrode 24 changes.

Thus, in the odd-numbered frame periods when the black voltage Vb is in the low level, the white voltage Vw becomes higher than the normal high level in the rectangular pulse manner in the beginning of each selection period. In the even-numbered frame periods when the black voltage Vb is in the high level, the white voltage Vw becomes lower than the normal low level in the rectangular pulse manner in the beginning of each selection period.

As described above, in the liquid crystal display device according to the present embodiment, the first voltage output circuit (white voltage output circuit 15) makes the first voltage (white voltage Vw) change in the rectangular pulse manner in accordance with the timing when the voltage of the pixel electrode 24 changes. According to the liquid crystal display device according to the present embodiment, the same effects attained by the first embodiment can be attained.

### Third Embodiment

A liquid crystal display device according to a third embodiment has the same configuration (FIGS. 1 to 3) as that of the liquid crystal display device 10 according to the first embodiment, and controls the black voltage in a manner similar to the white voltage. Differences from the first embodiment will be described below.

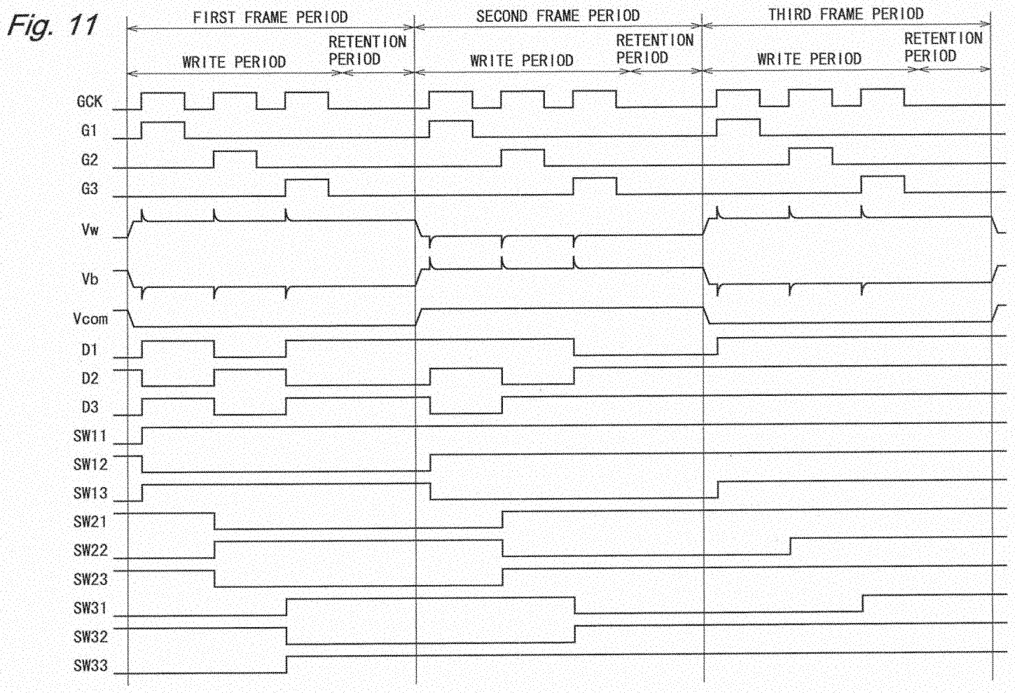

FIG. 11 is a timing chart of the liquid crystal display device according to the present embodiment. FIG. 11 describes changes of the signals and the voltage in the same case as FIG. 5 with respect to the liquid crystal display device according to the present embodiment.

As shown in FIG. 11, also in the liquid crystal display device according to the present embodiment, the white voltage output circuit 15 controls the white voltage Vw to have the level that is more distant from the black voltage Vb than the normal level, in accordance with the timing when the voltage of the pixel electrode 24 changes. In addition, in the present embodiment, the black voltage output circuit 16 controls the black voltage Vb to have a level that is more distant from the white voltage Vw than a normal level (final level that the black voltage Vb should have), in accordance with the timing when the voltage of the pixel electrode 24 changes. The black voltage output circuit 16 makes the black voltage Vb change in the impulse manner in accordance with the timing when the voltage of the pixel electrode 24 changes.

Thus, in the odd-numbered frame periods when the black voltage Vb is in the low level, in the beginning of each selection period, the white voltage Vw becomes higher than the normal high level in the impulse manner, and the black voltage Vb becomes lower than the normal low level in the impulse manner. In the even-numbered frame periods when the black voltage Vb is in the high level, in the beginning of each selection period, the white voltage Vw becomes lower than the normal low level in the impulse manner, and the black voltage Vb becomes higher than the normal high level in the impulse manner.

As described above, in the liquid crystal display device according to the present embodiment, the second voltage output circuit (black voltage output circuit 16) controls the second voltage (black voltage Vb) to have the level that is more distant from the first voltage (white voltage Vw) than the normal level (a level lower than the normal low level, or a level higher than the normal high level), in accordance with the timing when the voltage of the pixel electrode 24 changes. The second voltage output circuit makes the second voltage change in the impulse manner in accordance with the timing when the voltage of the pixel electrode 24 changes. According to the liquid crystal display device according to the present embodiment, in addition to the afterimage caused by the orientation abnormality that occurs when the color of the pixel is made to change from a color corresponding to the second voltage to the color corresponding to the first voltage, the afterimage caused by the orientation abnormality that occurs when the color of the pixel is made to change from the color corresponding to the first voltage to the color corresponding to the second voltage can be prevented.

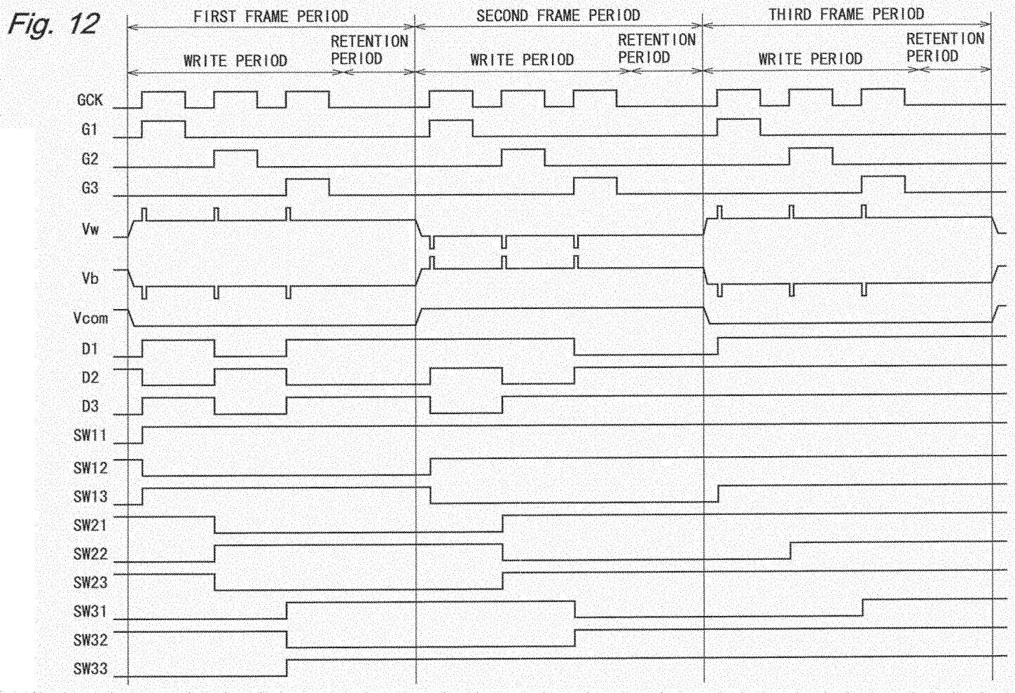

As for the present embodiment, a following modification example can be configured. In the liquid crystal display device according to the modification example, in accordance with the timing when the voltage of the pixel electrode 24 changes, the white voltage output circuit 15 makes the white voltage Vw change in the rectangular pulse manner, and the black voltage output circuit 16 makes the black voltage Vb change in the rectangular pulse manner. FIG. 12 is a timing chart of the liquid crystal display device according to the modification example. According to the liquid crystal display device according to the modification example, same effects attained by the liquid crystal display device according to the third embodiment can be attained.

### Fourth Embodiment

A liquid crystal display device according to a fourth embodiment has a configuration in which the white voltage output circuit 15 is replaced with a later-described circuit in the liquid crystal display device 10 according to the first embodiment (FIG. 1), and controls the white voltage in a manner different from that of the first embodiment. Differences from the first embodiment will be described below.

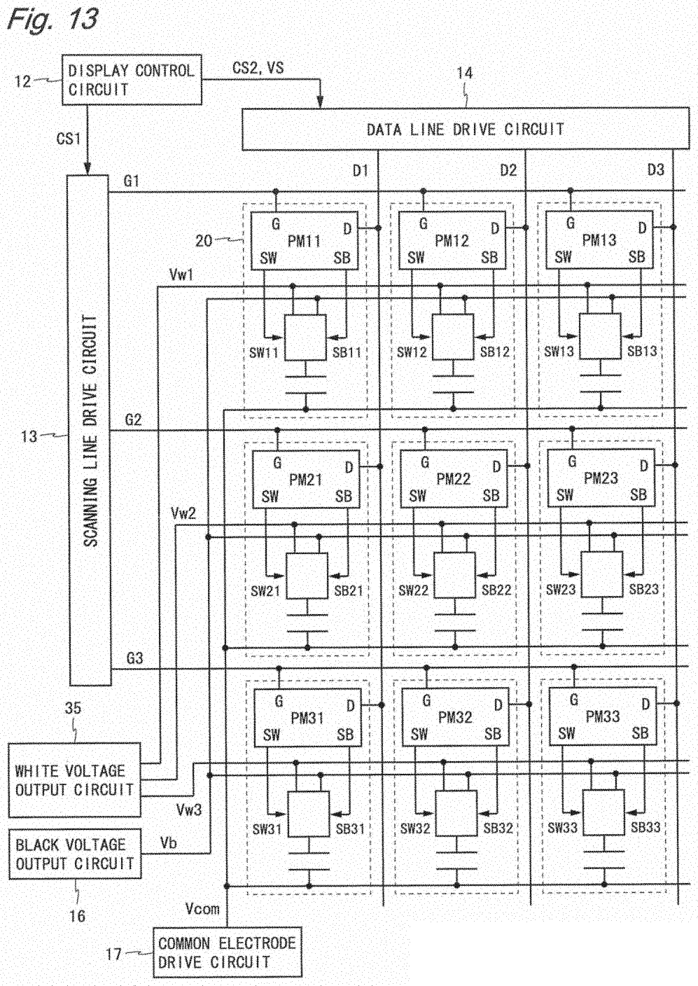

FIG. 13 is a diagram showing a detailed configuration of the liquid crystal display device according to the present embodiment. The liquid crystal display device shown in FIG. 13 includes a white voltage output circuit 35 in place of the white voltage output circuit 15. The pixel circuits 20 are classified into three groups corresponding to the scanning lines G1 to G3. The pixel circuits 20 in the first row are classified as a first group, the pixel circuits 20 in a second row are classified as a second group, and the pixel circuits 20 in a third row are classified as a third group. The white voltage output circuit 35 outputs, as the white voltage, three voltages corresponding to the three groups. The white voltage output circuit 35 outputs a white voltage Vw1 corresponding to the first group, outputs a white voltage Vw2 corresponding to the second group, and outputs a white voltage Vw3 corresponding to the third group. The white voltage output circuit 35 controls the white voltage corresponding to an i-th group to have a level that is more distant from the black voltage Vb than the normal level, in accordance with a timing when the voltage of the pixel electrode 24 in the pixel circuit 20 in the i-th group changes.

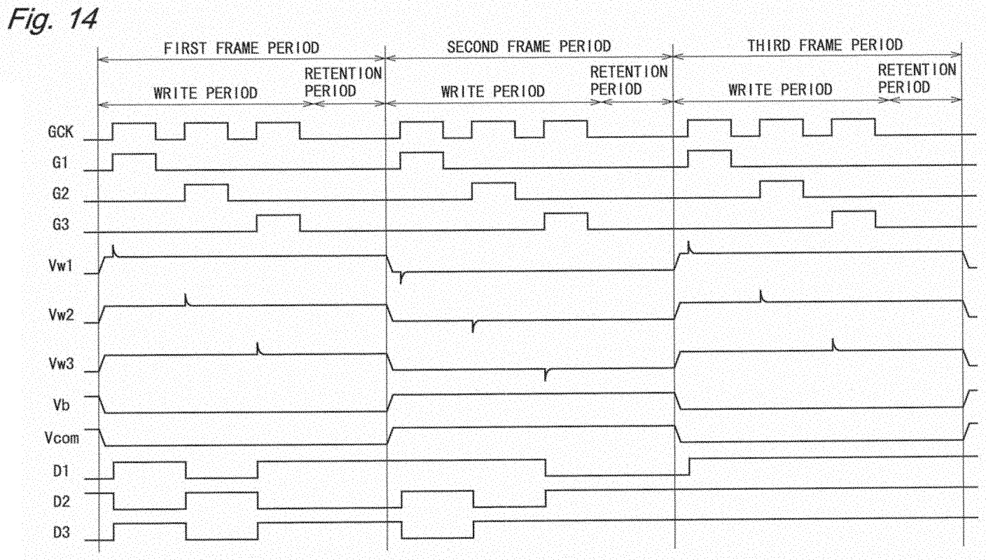

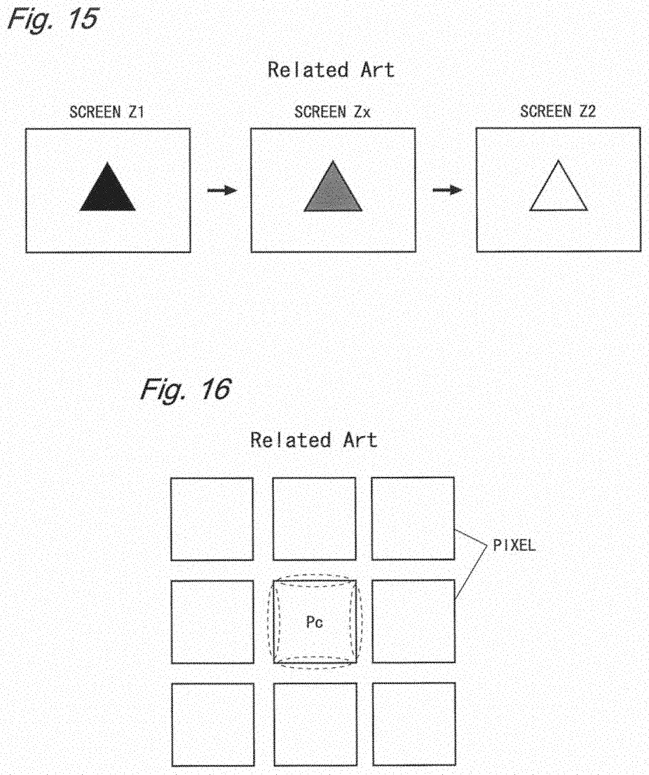

FIG. 14 is a timing chart of the liquid crystal display device according to the present embodiment. FIG. 14 describes changes of the signals and the voltages in the same case as FIG. 5 with respect to the liquid crystal display device according to the present embodiment. In the liquid crystal display device according to the present embodiment, the voltage of the pixel electrode 24 in the pixel circuit 20 in the first row changes in the beginning of the first selection period, the voltage of the pixel electrode 24 in the pixel circuit 20 in the second row changes in the beginning of the second selection period, and the voltage of the pixel electrode 24 in the pixel circuit 20 in the third row changes in the beginning of the third selection period (not shown).

In the control period set in the beginning of the first selection period, the white voltage output circuit 35 controls the white voltage Vw1 to have the level that is more distant from the black voltage Vb than the normal level in the impulse manner. In the control period set at the beginning the second selection period, the white voltage output circuit 35 controls the white voltage Vw2 to have the level that is more distant from the black voltage Vb than the normal level in the impulse manner. In the control period set in the beginning of the third selection period, the white voltage output circuit 35 controls the white voltage Vw3 to have the level that is more distant from the black voltage Vb than the normal level in the impulse manner.

Thus, in the odd-numbered frame periods when the black voltage Vb is in the low level, the white voltage Vw1 becomes higher than the normal high level in the impulse manner in the beginning of the first selection period, the white voltage Vw2 becomes higher than the normal high level in the impulse manner in the beginning of the second selection period, and the white voltage Vw3 becomes higher than the normal high level in the impulse manner in the beginning of the third selection period. In the even-numbered frame periods when the black voltage Vb is in the high level, the white voltage Vw1 becomes lower than the normal low level in the impulse manner in the beginning of the first selection period, the white voltage Vw2 becomes lower than the normal low level in the impulse manner in the beginning of the second selection period, and the white voltage Vw3 becomes lower than the normal low level in the impulse manner in the beginning of the third selection period.

As described above, in the liquid crystal display device according to the present embodiment, the pixel circuits 20 are classified into groups corresponding to the scanning lines G1 to Gm, and the first voltage output circuit (white voltage output circuit 35) outputs, as the first voltage (white voltage), voltages (white voltages Vw1, Vw2, Vw3) corresponding to the groups, and controls the first voltage that corresponds to the group, in accordance with a timing when the voltage of the pixel electrode 24 in the pixel circuit 20 in the group changes. According to the liquid crystal display device according to the present embodiment, effects similar to those attained by the first embodiment can be attained. In addition, since the first voltage output circuit outputs the voltages as the first voltage, wirings that propagate the first voltage can be divided, capacitance of the wirings can be reduced, and the wirings that propagate the first voltage can be driven easily.

As for the above-described liquid crystal display device according to each embodiment, a variety of modification examples can be configured. For example, by arbitrarily combining features of each embodiment unless contrary to their characteristics, a liquid crystal display device having features of a plurality of embodiments may be configured. In a liquid crystal display device according to a modification example of the fourth embodiment, the white voltage output circuit may make the white voltages Vw1 to Vw3 change in the rectangular pulse manner. In a liquid crystal display device according to a modification example of the first and second embodiments, the black voltage output circuit may make the black voltage Vb change in the impulse manner or in the rectangular pulse manner. In a liquid crystal display device according to a modification example of the fourth embodiment, the black voltage output circuit may output, as the black voltage, voltages corresponding to the groups. Furthermore, a liquid crystal display device according to a modification example may include a pixel circuit other than the pixel circuit 20 shown in FIG. 3. For example, a liquid crystal display device according to a modification example may include a pixel circuit obtained by removing the TFTs Q8, Q9 from the pixel circuit 20, in place of the pixel circuit 20.

Although the present invention is described in detail in the above, the above description is exemplary in all of the aspects and is not restrictive. It is understood that various other changes and modification can be derived without going out of the present invention.

What is claimed is:

1. A reflective type liquid crystal display device performing binary display, the device comprising:
a display section including scanning lines, data lines, and pixel circuits;
a scanning line drive circuit configured to drive the scanning lines;
a data line drive circuit configured to drive the data lines;
a first voltage output circuit configured to output a first voltage; and
a second voltage output circuit configured to output a second voltage, wherein
the pixel circuit includes a liquid crystal capacitance having a pixel electrode, and is configured to apply one of the first voltage and the second voltage to the pixel electrode in accordance with data written by driving the scanning line and the data line, and
the first voltage output circuit is configured to control the first voltage to have a level that is more distant from the second voltage than a normal level, in accordance with a timing when a voltage of the pixel electrode changes.

2. The liquid crystal display device according to claim 1, wherein the first voltage output circuit is configured to make the first voltage change in an impulse manner in accordance with the timing.

3. The liquid crystal display device according to claim 1, wherein the first voltage output circuit is configured to make the first voltage change in a rectangular pulse manner in accordance with the timing.

4. The liquid crystal display device according to claim 1, wherein the second voltage output circuit is configured to control the second voltage to have a constant level in a frame period.

5. The liquid crystal display device according to claim 1, wherein the second voltage output circuit is configured to control the second voltage to have a level that is more distant from the first voltage than a normal level, in accordance with the timing.

6. The liquid crystal display device according to claim 5, wherein the second voltage output circuit is configured to make the second voltage change in an impulse manner in accordance with the timing.

7. The liquid crystal display device according to claim 5, wherein the second voltage output circuit is configured to make the second voltage change in a rectangular pulse manner in accordance with the timing.

8. The liquid crystal display device according to claim 1, wherein the first voltage output circuit is configured to output, as the first voltage, a same voltage to all of the pixel circuits, and to control the first voltage in accordance with all of the timings when the voltage of the pixel electrode changes.

9. The liquid crystal display device according to claim 1, wherein
the pixel circuits are classified into groups corresponding to the scanning lines, and
the first voltage output circuit is configured to output, as the first voltage, voltages corresponding to the groups, and to control the first voltage that corresponds to the group, in accordance with a timing when the voltage of the pixel electrode in the pixel circuit in the group changes.

10. The liquid crystal display device according to claim 1, further comprising a common electrode drive circuit configured to drive a common electrode of the liquid crystal capacitance, wherein
the first voltage output circuit, the second voltage output circuit, and the common electrode drive circuit are configured to invert a level of a voltage output from each circuit, for each frame period.

11. The liquid crystal display device according to claim 1, wherein
the pixel circuit includes:
a write control transistor having a control terminal connected to the scanning line, and one conduction terminal connected to the data line;
a memory circuit configured to memorize the data input through the write control transistor, and to output a control signal in accordance with the data; and
a voltage selection circuit configured to apply one of the first voltage and the second voltage to the pixel electrode according to the control signal.

12. The liquid crystal display device according to claim 11, wherein
the memory circuit is a flip-flop circuit configured to output, as the control signal, a first control signal and a second control signal that change complementarily, and
the voltage selection circuit includes:
a transistor configured to apply the first voltage to the pixel electrode according to the first control signal;
a transistor configured to apply the second voltage to the pixel electrode according to the first control signal;
a transistor configured to apply the first voltage to the pixel electrode according to the second control signal; and
a transistor configured to apply the second voltage to the pixel electrode according to the second control signal.

13. A drive method of a reflective type liquid crystal display device having a display section including scanning lines, data lines, and pixel circuits, and performing binary display, the method comprising:
driving the scanning lines;
driving the data lines;
outputting a first voltage; and
outputting a second voltage, wherein
the pixel circuit includes a liquid crystal capacitance having a pixel electrode, and is configured to apply one of the first voltage and the second voltage to the pixel electrode in accordance with data written by driving the scanning line and the data line, and
in outputting the first voltage, the first voltage is controlled to have a level that is more distant from the second voltage than a normal level, in accordance with a timing when a voltage of the pixel electrode changes.
